(19) United States
(12) Patent Application Publication
(10) Pub. No.: US 2009/0117757 A1
(43) Pub. Date: May 7, 2009

(54) CONNECTING STRUCTURE OF CIRCUIT BOARDS, CONNECTING METHOD OF CIRCUIT BOARDS, AND COMPRESSING TOOL FOR CONNECTING CIRCUIT BOARDS

(75) Inventor: Hiroyuki Suzuki, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/063,600

(22) PCT Filed: Sep. 28, 2005
(86) PCT No.: PCT/JP2005/017862

§ 371 Date: Feb. 12, 2008

(51) Int. Cl. H01R 12/00; B23P 19/00

(52) U.S. Cl. 439/74; 439/66; 29/764

(57) ABSTRACT

An object of the invention is to provide a connecting structure of circuit boards in which whether or not the circuit boards have been favorably connected can be more easily judged as compared with the prior art, even in case where connecting portions have been connected with pressure by arranging the connecting portions face to face, a connecting method of the circuit boards, and a compressing tool for connecting the circuit boards. A connecting structure 10 of circuit boards includes a first circuit board 11 and a second circuit board 12. A first connecting portion 17 of the first circuit board and a second connecting portion 21 of the second circuit board are arranged face to face interposing an adhesive 13, and clamped by a compressing tool 25 so that circuit patterns 16, 19 may be brought into contact with each other, whereby the first connecting portion 17 and the second connecting portion 21 will be connected with heat and pressure. In this connecting structure 10 of the circuit boards, a pair of unbonded parts 35 are formed in a compressing region 34 of a soft substrate 18 with which an upper compressing tool 26 is adapted to be contacted.

### TECHNICAL FIELD

The present invention relates to a connecting structure of circuit boards which connects a circuit board having a plurality of circuit patterns arranged on a soft substrate to another circuit board with heat and pressure, a connecting method of the circuit boards, and a compressing tool for connecting the circuit boards.

### BACKGROUND ART

In an electronic apparatus such as a mobile phone, for example, a connecting portion in a circuit board of a hard substrate and a connecting portion in a circuit board of a soft substrate are connected to each other in a casing.

In each of the connecting portions, a plurality of circuit patterns are arranged in parallel along a same plane of the hard or soft substrate.

These circuit boards are arranged in such a manner that their respective connecting portions are opposed face to face interposing an adhesive, and clamped by a pair of compressing tools, thereby to be connected to each other with heat and pressure.

On this occasion, the adhesive which has extruded from between the circuit patterns opposed face to face while heated and compressed will bond the substrates to each other, whereby the circuit patterns of the respective connecting portions will be fixed in a face contact manner.

In the connecting structure of the circuit boards as described above, there has been such inconvenience that it is impossible to directly recognize a connected state of the connecting portions, because of structural reason that the respective connecting portions are arranged face to face, and thereafter, the circuit boards are connected with heat and pressure by a pair of compressing tools.

In a field of the connecting structure of the circuit boards as described above, there have been proposed a terminal connecting structure of a liquid crystal display panel in which a degree of parallelity and a degree of flatness of a compressing face of the compressing tool can be adjusted by operating a pushing screw and a pulling screw which are provided in parallel on an upper face of the compressing tool (Patent Document 1), a compression boding apparatus in which a recess portion is formed on a compressing face of a compressing tool, whereby an adhesive extruded by compression can be prevented from adhering to the compressing face (Patent Document 2), and so on.

Patent Document 1: JP-A-8-320498

Patent Document 2: JP-A-9-298.359

### DISCLOSURE OF THE INVENTION

### Problems that the Invention is to Solve

However, the invention of Patent Document 1 has been made for the purpose of obtaining the degree of parallelity and the degree of flatness of the compressing face, and the invention of Patent Document 2 has been made for the purpose of preventing the excessive adhesive from adhering to the compressing face. Therefore, those inventions do not solve the above described inconvenience.

This invention has been made in order to solve the above described inconvenience, and its object is to provide a connecting structure of circuit boards in which whether the circuit boards have been favorably connected or not can be more easily judged as compared with the prior art, even in case where connecting portions have been connected with pressure by arranging the connecting portions face to face, a connecting method of the circuit boards, and a compressing tool for connecting the circuit boards.

### Means for Solving the Problems

According to the invention, there is provided a connecting structure of circuit boards comprising,

a first circuit board having a first connecting portion in which a plurality of circuit patterns are arranged in parallel on a same face of a hard substrate; and

a second circuit board having a second connecting portion in which a plurality of circuit patterns are arranged in parallel on a same face of a soft substrate,

wherein the first connecting portion and the second connecting portion are arranged face to face interposing an adhesive, and clamped between a pair of compressing tools so that the circuit patterns are brought into contact with each other to connect the first and second connecting portions with heat and pressure; and

wherein a recess portion is formed on a compressing face of the compressing tool which comes into contact with the soft substrate.

In the invention as described above, when the first connecting portion and the second connecting portion have been clamped by the compressing tool and connected with heat and pressure, a region subjected to a lower compression force will be created in a compressing region, due to the recess portion which is formed on the compressing face of the compressing tool, and the region has an outer appearance different from the other parts.

Specifically, in case where the adhesive having lower viscosity is employed in this invention, the region subjected to the lower compression force, that is, the region corresponding to the recess portion will be an unbonded part in which the adhesive will not get in touch with the soft substrate. In this connecting structure of the circuit boards, it will be possible to discriminate the above described unbonded part from the bonded part in which the adhesive has been adhered to the soft substrate, because of respectively different colors are appeared on the soft substrate.

On the other hand, in case where the adhesive having higher viscosity is employed in this invention, the soft substrate will be pushed up with a pushing force of the adhesive, whereby the projected part will be formed. Because plastic deformation of the soft substrate is relatively easily performed, the projected part will be formed by pushing up the soft substrate with the pushing force of the adhesive.

Specifically, prior to the connection with heat and pressure, the adhesive will be dropped in advance on a determined point of the first connecting portion or the second connecting portion, and will spread while heated and compressed. A fact that the unbonded part or the projected part is formed after spread of the adhesive means that the connecting portions have been filled with the adhesive from the dropping point to the point where the unbonded part or the projected part is formed.

As the results, by visually observing the projected part, it is possible to confirm that the first and second connecting portions have been favorably bonded to each other by means of the adhesive.

Moreover, the connecting structure of circuit boards according to the invention is characterized in that an unbonded part is formed in the soft substrate at a position corresponding to the recess portion.

Further, the connecting structure of circuit boards according to the invention is characterized in that a projected part is formed in the soft substrate at a position corresponding to the recess portion.

In this invention, in case where the projected part is formed outward by a determined length from both end parts in a direction of arrangement of the circuit patterns, it is possible to reliably keep the circuit patterns of the first circuit board and the circuit patterns of the second circuit board in a mutually contacted state.

Moreover, in this invention, in case where the length of separation between the projected part and both ends in the direction of arrangement is more than twice as large as a width of the circuit pattern, it is possible to keep more reliably the circuit patterns of the first circuit board and the circuit patterns of the second circuit board in the mutually contacted state.

Further, according to the invention, there is provided a connecting method of circuit boards a first circuit board having a first connecting portion in which a plurality of circuit patterns are arranged in parallel on a same face of a hard substrate and a second circuit board having a second connecting portion in which a plurality of circuit patterns are arranged in parallel on a same face of a soft substrate, the connecting method comprising:

arranging the first connecting portion and the second connecting portion face to face interposing an adhesive;

clamping the first connecting portion and the second connecting portion between a pair of compressing tools so that the circuit patterns are brought into contact with each other to connect the first and second connecting portions with heat and pressure; and

forming a recess portion on a compressing face of the compressing tool which comes into contact with the soft substrate previously.

By forming the recess portion in advance on the compressing face of the compressing tool, the above described unbonded part or projected part can be formed when the soft substrate is pressed by the compressing face, and hence, it is possible to confirm that the first and second connecting portions have been favorably bonded to each other by means of the adhesive.

Still further, according to the invention, there is provided a compressing tool for connecting circuit boards which connects a first circuit board having a first connecting portion in which a plurality of circuit patterns are arranged in parallel on a same face of a hard substrate, and a second circuit board having a second connecting portion in which a plurality of circuit patterns are arranged in parallel on a same face of a soft substrate to each other, the compressing tool clamps the first connecting portion and the second connecting portion which are arranged face to face interposing an adhesive so that the connecting portions are brought into contact with each other, and heats and compresses the first and second connecting portions, wherein a recess portion is formed on a compressing face of the compressing tool which comes into contact with the soft substrate.

By forming the recess portion in advance on the compressing face of the compressing tool, the above described unbonded part or projected part can be formed when the soft substrate is pressed by the compressing face, and hence, it is possible to confirm that the first and second connecting portions have been favorably bonded to each other by means of the adhesive.

### ADVANTAGE OF THE INVENTION

According to the invention, because the unbonded part or the projected part has been formed, it is possible to confirm that the connecting portions have been favorably bonded to each other by the adhesive. As the results, there is such advantage that when the connecting portions have been arranged face to face and connected with pressure, whether or not the circuit boards have been favorably connected can be more easily judged as compared with the prior art.

### BRIEF DESCRIPTION OF THE DRAWINGS

FIGS. 1(A) and (B) are views showing a connecting structure of circuit boards and a compressing tool for connecting the circuit boards in a first embodiment according to the invention.

FIGS. 2(A) and (B) are views showing an upper compressing tool of the compressing tool in the first embodiment.

FIGS. 3(A) and (B) are views showing the connecting structure of the circuit boards in the first embodiment.

FIGS. 4(A) and (B) are views showing a second embodiment according to the invention.

FIGS. 5(A), (B) and (C) are plan views showing modifications 1 to 3 of the upper compressing member according to the invention.

FIGS. 6(A) and (B) are plan views showing modifications 4 to 5 of the upper compressing member according to the invention.

FIGS. 7 (A), (B) and (C) are plan views showing modifications 6 to 8 of the upper compressing member according to the invention.

### DESCRIPTION OF REFERENCE NUMERALS AND SIGN

10, 110 Connecting structure of circuit board
11 First circuit board
12 Second circuit board
13 Adhesive
15 Soft substrate
15A Same face of soft substrate
16, 19 Circuit pattern
16A, 19A Both ends of circuit pattern in a direction of arrangement
17 First connecting portion
18 Soft substrate
18A Same face of soft substrate
21 Second connecting portion
25 Compressing tool
26, 40, 45, 50, 55, 60, 65, 70, 75 Upper compressing tool
27 Lower compressing tool
28 Compressing face
29, 41, 46, 51, 56, 61, 66, 71, 76 Recess portion
34 Compressing region
35 Unbonded part
135 Projected part
W1 Length of separation between projected part and both ends in a direction of arrangement
W2 Width of circuit pattern

### BEST MODE FOR CARRYING OUT THE INVENTION

### First Embodiment

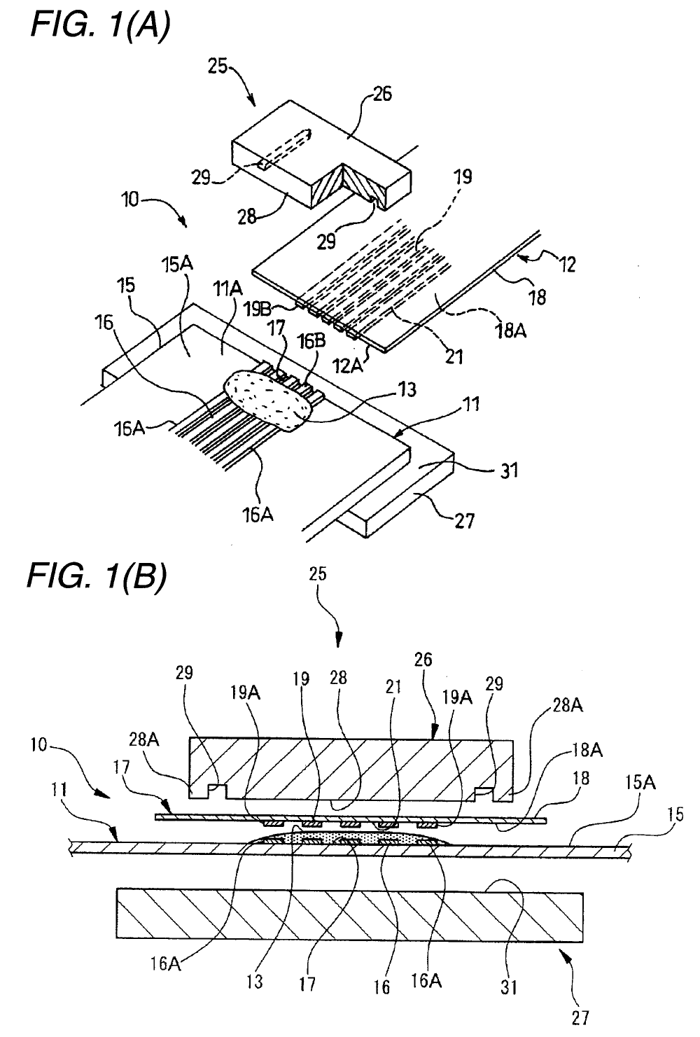

As shown in FIG. 1, a connecting structure 10 of circuit boards according to the first embodiment of the invention includes a first circuit board 11 and a second circuit board 12 which are connected to each other with heat and pressure, in a state where an adhesive 13 is interposed between the first circuit board 11 and the second circuit board 12.

The first circuit board 11 has a plurality of circuit patterns 16 which are arranged in parallel on a same face 15A of a hard substrate 15, and a first connecting portion 17 near an end part 11A.

On the other hand, the second circuit board 12 has a plurality of circuit patterns 19 on a same face 18A of a soft substrate 18, and a second connecting portion 21 near an end part 12A.

In the connecting structure 10 of the circuit boards, the first connecting portion 17 and the second connecting portion 21 are arranged face to face interposing the adhesive 13, and clamped by a compressing tool 25 (the compressing tool for connecting the circuit boards) so that the circuit patterns 16 and 19 may be brought into contact with each other, whereby the first connecting portion 17 and the second connecting portion 21 will be connected with heat and pressure.

In the first embodiment, the adhesive 13 having relatively lower viscosity is employed.

The compressing tool 25 for connecting the circuit boards according to the invention is employed for clamping the first connecting portion 17 and the second connecting portion 21 which have been arranged face to face interposing the adhesive, and at the same time, for heating and compressing the first connecting portion 17 and the second connecting portion 21 so that they may be brought into contact with each other, for the purpose of connecting the first circuit board 11 to the second circuit board 12.

This compressing tool 25 includes an upper compressing tool 26 and a lower compressing tool 27. These upper compressing tool 26 and lower compressing tool 27 constitute a pair of the compressing tool which will clamp the first connecting portion 17 and the second connecting portion 21 therebetween.

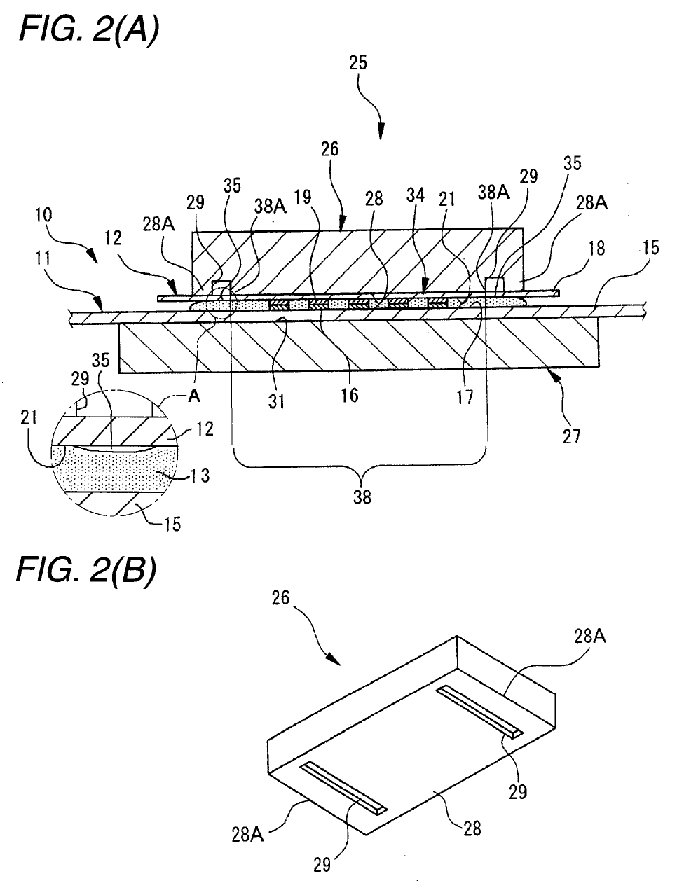

As shown in FIG. 2, the upper compressing tool 26 is a tool of which a compressing face 28 adapted to come into contact with the soft substrate 18 is formed flat in a substantially rectangular shape. A pair of recess portions 29 are formed on the compressing face 28 near both side parts 28A.

Each of the recess portions 29 is a single groove formed along a side end 28A of the compressing face 28. Because the recess portion 29 is formed as the single groove, workability will be enhanced.

When the soft substrate 18 has been pressed with the compressing face 28, regions subjected to a lower compression force will be created partially corresponding to the recess portions 29, because a pair of the recess portions 29 are formed on the compressing face 28 of the upper compressing tool 26.

Therefore, the regions in the second circuit board 12 to be subjected to the lower compression force, that is, the regions corresponding to the recess portions 29 will become unbonded parts 35 in which the adhesive 13 does not get in touch with the soft substrate 18.

In this connecting structure 10 of the circuit board, the aforethe unbonded parts 35 can be discriminated from the parts in which the adhesive 13 has been normally adhered to the soft substrate 18, because of respectively different colors are appeared on the soft substrate 18.

Although a space is formed between the adhesive 13 and the soft substrate 18 in an enlarged view of the unbonded part 35 in FIG. 2(A), the space is drawn exaggeratedly for assisting understanding, and actually, there is almost no space.

The lower compressing tool 27 is a tool of which a compressing face 31 adapted to come into contact with the hard substrate 15 is formed flat in a substantially rectangular shape.

The first connecting portion 17 and the second connecting portion 21 will be clamped between the upper compressing tool 26 and the lower compressing tool 27, and will be heated and compressed. In this manner, the first connecting portion 17 and the second connecting portion 21 will be brought into contact with each other in a state arranged face to face interposing the adhesive, whereby the connecting structure 10 of the circuit boards will be obtained.

In the connecting structure 10 of the circuit boards, a pair of the unbonded parts 35 are formed in a compressing region 34 of the soft substrate 18 with which the upper compressing tool 26 comes into contact.

A pair of the unbonded parts 35 are formed, because the adhesive 13 has not come into contact with the soft substrate 18 in the regions corresponding to the recess portions 29.

Accordingly, it is apparent that the first connecting portion 17 and the second connecting portion 21 have been bonded by the adhesive 13, up to the regions containing a pair of the unbonded parts 35.

As the results, it is possible to confirm that the first connecting portion 17 and the second connecting portion 21 have been favorably bonded by the adhesive 13, by visually observing the color of a pair of the unbonded parts 35.

Specifically, it is possible to confirm that the first connecting portion 17 and the second connecting portion 21 have been favorably bonded by the adhesive 13 up to both side parts 38A of a bonding region 38, as shown in FIG. 2(A).

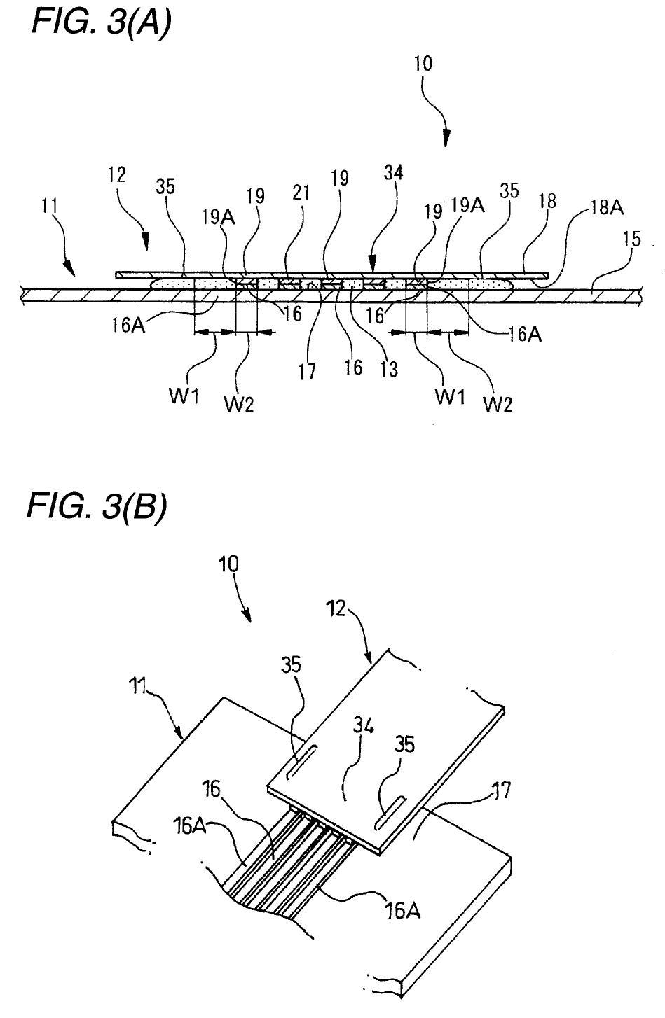

As shown in FIG. 3, a pair of the unbonded parts 35 are respectively formed outward by a determined length (a length of separation) W1 from both end parts 16A in a direction of arrangement of the circuit patterns 16 in the first connecting portion 17.

In the same manner, a pair of the unbonded parts 35 are respectively formed outward by a determined length (a length of separation) W1 from both end parts 19A in a direction of arrangement of the circuit patterns 19 in the second connecting portion 21.

Accordingly, the regions outside both the end parts 16A, 19A in the direction of arrangement of the circuit patterns 16, 19 can be bonded by the adhesive 13.

In this manner, the circuit patterns 16 on the first circuit board 11 and the circuit patterns 19 on the second circuit board 12 will be reliably maintained in a state contacted with each other.

Moreover, the length of separation W1 between a pair of the unbonded parts 35 and both the ends 16A in the direction of arrangement is more than twice as large as a width W2 of each of the circuit patterns 16.

In the same manner, the length of separation W1 between a pair of the unbonded parts 35 and both the ends 19A in the direction of arrangement is more than twice as large as a width W2 of each of the circuit patterns 19.

In this manner, the circuit patterns 16 on the first circuit board 11 and the circuit patterns 19 on the second circuit board 12 will be more reliably maintained in the state contacted with each other.

Now, a method of connecting the circuit boards according to the invention will be described referring to FIGS. 1 to 3.

As shown in FIG. 1(A) and FIG. 1(B), the first circuit board 11 having a plurality of the circuit patterns 16 which are arranged in parallel on the same face 15A of the hard substrate 15 and having the first connecting portion 17 will be prepared.

Moreover, the second circuit board 12 having a plurality of the circuit patterns 19 which are arranged in parallel on the same face 18A of the soft substrate 18 and having the second connecting portion 21 will be prepared.

The adhesive 13 will be applied to the first connecting portion 17 of the first circuit board 11. The second connecting portion 21 will be arranged so as to be opposed to the first connecting portion 17 to which the adhesive 13 has been applied.

In this state, the hard substrate 15 of the first circuit board 11 will be placed on the compressing face 31 of the lower compressing tool 27, as shown in FIG. 2(A). Then, the compressing face 28 of the upper compressing tool 26 will be placed on the soft substrate 18 of the second circuit board 12.

Then, the first connecting portion 17 and the second connecting portion 21 will be clamped between the upper and lower compressing tools 26, 27, and will be connected with heat and pressure so that the circuit patterns 16, 19 of the first circuit board 11 and the second circuit board 12 may come into contact with each other.

In this embodiment, a pair of the recess portions 29 have been formed in advance, as shown in FIG. 2(B), on the compressing face 28 of the upper compressing tool 26, near both the side parts 28A.

Accordingly, by compressing the soft substrate 18 with the compressing face 28 of the upper compressing tool 26, a pair of the unbonded parts 35 will be formed in the compressing region 34 which is in contact with the upper compressing tool 26.

As the results, it is possible to confirm that the first connecting portion 17 and the second connecting portion 21 have been favorably bonded to each other, by visually observing a pair of the unbonded parts 35.

### Second Embodiment

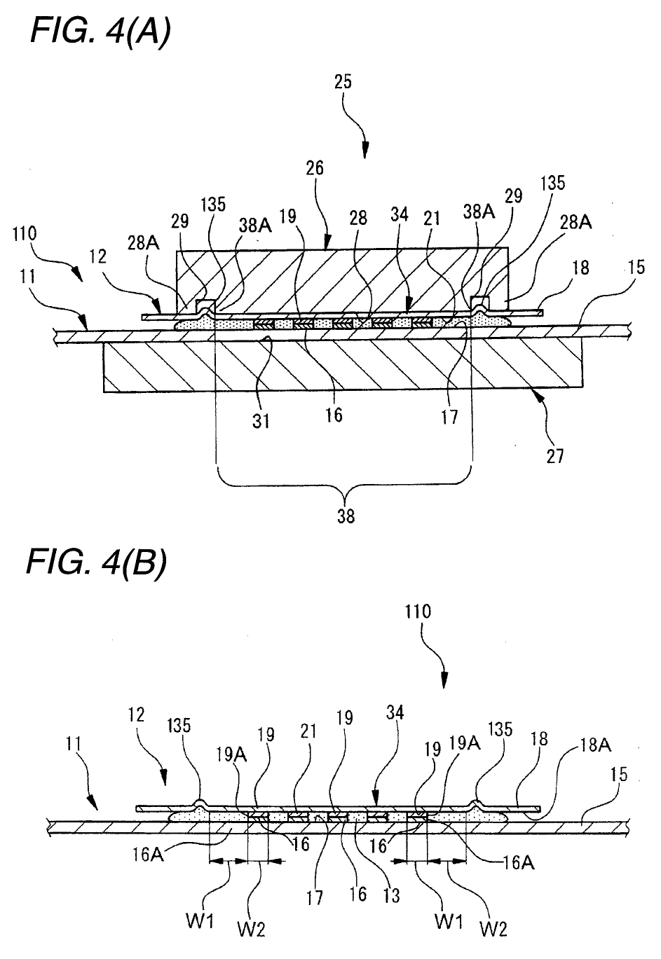

FIG. 4 shows a second embodiment of the invention.

It is to be noted that in the second embodiment which will be described below, those members which have been already described in the first embodiment will be denoted with the same or equivalent numerals or signs, and description of them will be simplified or omitted.

In the second embodiment as shown in FIG. 4, the adhesive 13 having relatively high viscosity is employed. Therefore, in a connecting structure 110 of circuit boards in the second embodiment, the hard substrate 15 of the first circuit board 11 will be placed on the compressing face 31 of the lower compressing tool 27, and the compressing face 28 of the upper compressing tool 26 will be placed on the soft substrate 18 of the second circuit board 12 thereby to clamp the substrates 15, 18 between the upper compressing tool 26 and the lower compressing tool 27, and to connect the substrates with heat and pressure (See FIG. 4(A)). Then, the adhesive 13 will partially bulge the soft substrate 18 corresponding to the recess portions 29 which have been formed on the compressing face 28 of the upper compressing tool 26, whereby a pair of projected parts 135 will be formed in the soft substrate 18 (See FIG. 4(B)).

In this second embodiment, it is apparent that the first connecting portion 17 and the second connecting portion 21 have been bonded to each other with the adhesive 13 up to regions containing a pair of the projected parts 135. As the results, it is possible to confirm that the first connecting portion 17 and the second connecting portion 21 have been favorably bonded to each other by the adhesive 13, by visually observing a pair of the projected parts 135.

In this second embodiment, a pair of the projected parts 135 are respectively formed outward by a determined length (a length of separation) W1 from both end parts 16A in a direction of arrangement of the circuit patterns 16 in the first connecting portion 17, and are respectively formed outward by a determined length (a length of separation) W1 from both end parts 19A in a direction of arrangement of the circuit patterns 19 in the second connecting portion 21.

Moreover, the length of separation W1 between a pair of the projected parts 135 and both the ends 16A in the direction of arrangement is more than twice as large as a width W2 of each of the circuit patterns 16, and the length of separation W1 between a pair of the projected parts 135 and both the ends 19A in the direction of arrangement is more than twice as large as a width W2 of each of the circuit patterns 19.

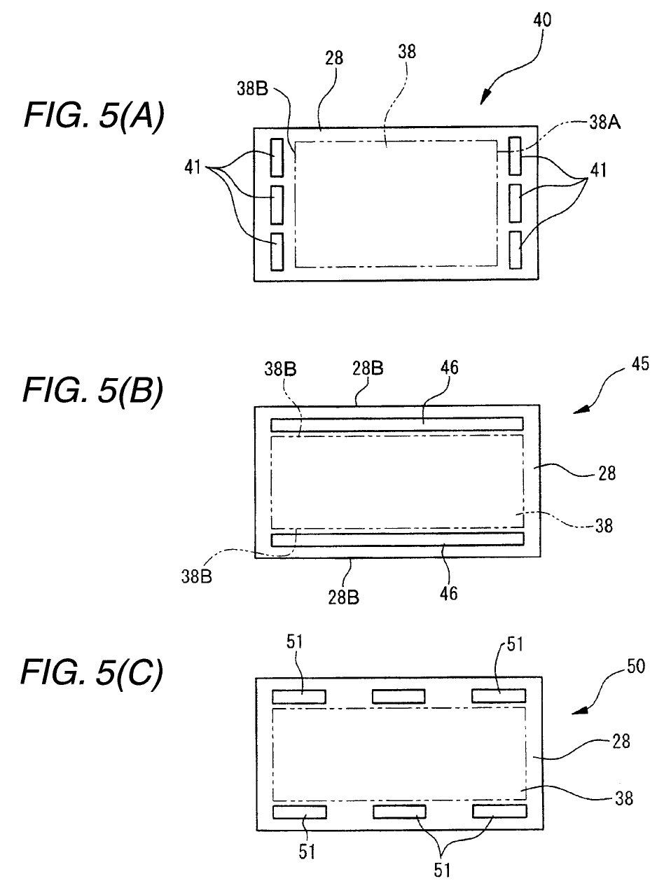

Then, modifications of the upper compressing tool 26 will be described referring to FIGS. 5 to 7. It is to be noted that the members which are the same as or similar to those members in the above described embodiments will be denoted with the same reference numerals in FIGS. 5 to 7, and description of them will be omitted.

An upper compressing tool 40 in modification 1 as shown in FIG. 5(A) is provided with recess portions 41 which are formed by dividing the recess portion 29 in the first embodiment into three. The upper compressing tool 40 is substantially the same as the upper compressing tool 26 in respect of other structures.

Because the recess portion 29 has been divided into the three recess portions 41, the region of the recess portions will be decreased, and hence, it is possible to enhance rigidity of the upper compressing tool 40.

An upper compressing tool 45 in modification 2 as shown in FIG. 5(B) is provided with recess portions 46 in place of the recess portions 29 in the first embodiment. The upper compressing tool 45 is substantially the same as the upper compressing tool 26 in respect of other structures.

The recess portions 46 are grooves which have been formed near the upper and lower end parts 28B of the compressing face 28.

By forming the recess portions 46 near the upper and lower end parts 28B of the compressing face 28, it is possible to confirm that the first connecting portion 17 and the second connecting portion 21 have been favorably bonded to each other with the adhesive 13, between the end parts 16B of the circuit patterns 16 (See FIG. 1(A)) and the end parts 19B of the circuit patterns 19 (See FIG. 1(A)).

In other words, it is possible to confirm that the first connecting portion 17 and the second connecting portion 21 have been favorably bonded to each other with the adhesive 13 up to upper and lower ends 38B of a bonding region 38.

Moreover, because the recess portion 46 is in a form of a single groove, workability will be enhanced.

An upper compressing tool 50 in modification 3 as shown in FIG. 5(C) is provided with recess portions 51 each of which is formed by dividing the recess portion 46 in modification 2 into three. The upper compressing tool 50 is substantially the same as the upper compressing tool 45 in respect of other structures.

Because the recess portion 46 has been divided into the three recess portions 51, the region of the recess portions will be decreased, and hence, it is possible to enhance rigidity of the upper compressing tool 50.

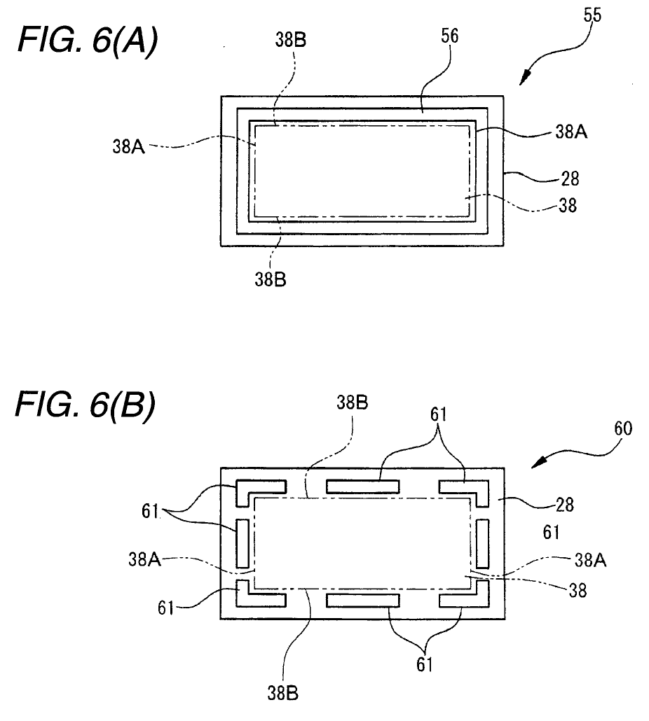

An upper compressing tool 55 in modification 4 as shown in FIG. 6(A) is provided with a recess portion 56 which is formed by unifying the recess portions 29 in the first and second embodiments and the recess portions 46 in modification 2. The upper compressing tool 55 is substantially the same as the upper compressing tool 26 in the first and second embodiments in respect of other structures.

The recess portion 56 is formed in a shape of substantially rectangular frame by unifying the recess portions 29 and the recess portions 46.

Because the recess portion 56 is formed in a shape of substantially rectangular frame, it is possible to confirm that the first connecting portion 17 and the second connecting portion 21 have been favorably bonded to each other with the adhesive 13 up to right and left sides 38A and up to the upper and lower ends 38B of the bonding region 38, that is, all over the bonding region 38.

An upper compressing tool 60 in modification 5 as shown in FIG. 6(B) is provided with recess portions 61 each of which is formed by dividing the recess portion 56 in modification 4 into eight. The upper compressing tool 60 is substantially the same as the upper compressing tool 55 in respect of other structures.

Because the recess portion 56 has been divided into the eight recess portions 61, the region of the recess portions will be decreased, and hence, it is possible to enhance rigidity of the upper compressing tool 60.

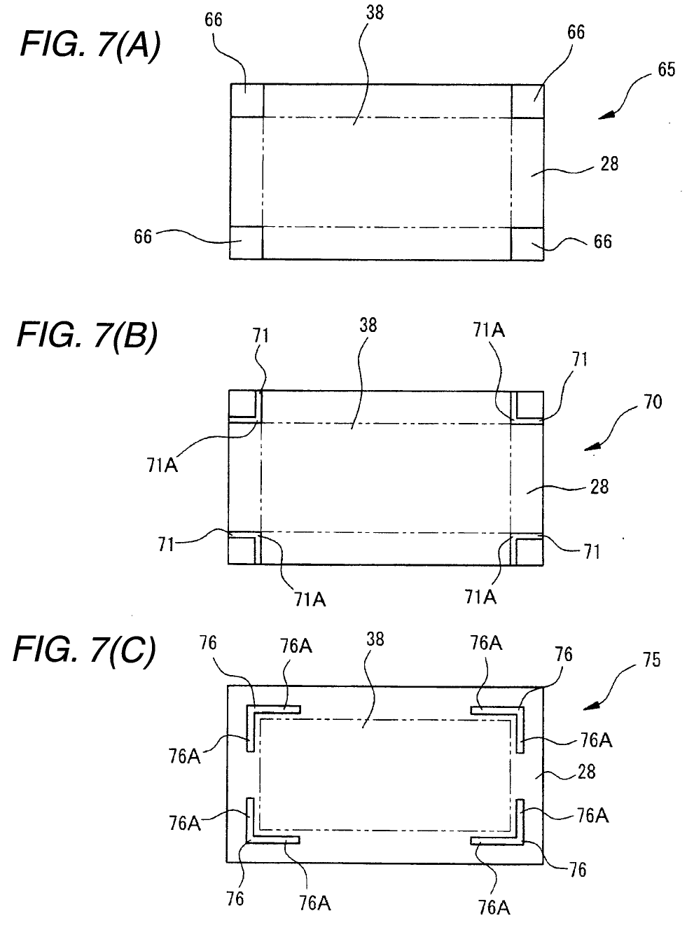

An upper compressing tool 65 in modification 6 as shown in FIG. 7(A) is provided with recess portions 66 respectively in four corners of the bonding region 38. The upper compressing tool 65 is substantially the same as the upper compressing tool 26 in the above described embodiments in respect of other structures.

Because the recess portions 66 are formed in the four corners of the bonding region 38, it is possible to confirm that the first connecting portion 17 and the second connecting portion 21 have been favorably bonded to each other with the adhesive 13 up to the four corners of the bonding region 38, that is, all over the bonding region 38.

Because the recess portions 66 are formed only in the four corners of the bonding region 38, the region of the recess portions can be decreased, and hence, it is possible to enhance rigidity of the upper compressing tool 65.

An upper compressing tool 70 in modification 7 as shown in FIG. 7(B) is provided with recess portions 71 in place of the recess portions 66 in modification 6. The upper compressing tool 70 is substantially the same as the upper compressing tool 65 in modification 6 in respect of other structures.

The recess portions 71 are dents which are formed in a substantially rectangular shape, and their corner parts 71A are so arranged as to be opposed to the four corners of the bonding region 38.

Because the recess portions 71 are formed in the four corners of the bonding region 38, it is possible to confirm that the first connecting portion 17 and the second connecting portion 21 have been favorably bonded to each other with the adhesive 13 all over the bonding region 38.

Because the recess portions 71 are formed only in the four corners of the bonding region 38, the region of the recess portions can be decreased, and hence, it is possible to enhance rigidity of the upper compressing tool 70.

An upper compressing tool 75 in modification 8 as shown in FIG. 7(C) is provided with recess portions 76 in place of the recess portions 66 in modification 6. The upper compressing tool 75 is substantially the same as the upper compressing tool 65 in modification 6 in respect of other structures.

The recess portions 76 are dents which are formed in a substantially rectangular shape, and side pieces 76A of these recess portions are arranged along edges of the bonding region 38.

By forming the recess portions 76 in the four corners of the bonding region 38, it is possible to confirm that the first connecting portion 17 and the second connecting portion 21 have been favorably bonded to each other with the adhesive 13 up to the four corners of the bonding region 38, that is, all over the bonding region 38.

Because the recess portions 76 are formed only in the four corners of the bonding region 38, the region of the recess portions can be decreased, and hence, it is possible to enhance rigidity of the upper compressing tool 75.

In the above described modifications, the recess portions 29, 41, 46, 51, 61, 66, 71 and 76 formed on the compressing face 28 have been described as the grooves or dents. However, the recess portion is not limited to the groove or dent, but it is possible to form the recess portion as an opening.

### INDUSTRIAL APPLICABILITY

This invention can be favorably applied to a connecting structure of circuit boards for connecting a circuit board of soft substrate on which a plurality of circuit patterns are arranged to another circuit board with heat and pressure, a method of connecting the circuit boards, and a compressing tool for connecting the circuit boards.

1. A connecting structure of circuit boards comprising,
a first circuit board having a first connecting portion in which a plurality of circuit patterns are arranged in parallel on a same face of a hard substrate; and
a second circuit board having a second connecting portion in which a plurality of circuit patterns are arranged in parallel on a same face of a soft substrate,
wherein the first connecting portion and the second connecting portion are arranged face to face interposing an adhesive, and clamped between a pair of compressing tools so that the circuit patterns are brought into contact with each other to connect the first and second connecting portions with heat and pressure; and
wherein a recess portion is formed on a compressing face of the compressing tool which comes into contact with the soft substrate.

2. The connecting structure of circuit boards according to claim 1, wherein an unbonded part is formed in the soft substrate at a position corresponding to the recess portion.

3. The connecting structure of circuit boards according to claim 1, wherein a projected part is formed in the soft substrate at a position corresponding to the recess portion.

4. A connecting method of circuit boards which include a first circuit board having a first connecting portion in which a plurality of circuit patterns are arranged in parallel on a same face of a hard substrate and a second circuit board having a second connecting portion in which a plurality of circuit patterns are arranged in parallel on a same face of a soft substrate, the connecting method comprising:
arranging the first connecting portion and the second connecting portion face to face interposing an adhesive;
clamping the first connecting portion and the second connecting portion between a pair of compressing tools so that the circuit patterns are brought into contact with each other to connect the first and second connecting portions with heat and pressure; and
forming a recess portion on a compressing face of the compressing tool which comes into contact with the soft substrate previously.

5. A compressing tool for connecting circuit boards which connects a first circuit board having a first connecting portion in which a plurality of circuit patterns are arranged in parallel on a same face of a hard substrate, and a second circuit board having a second connecting portion in which a plurality of circuit patterns are arranged in parallel on a same face of a soft substrate to each other,
the compressing tool clamps the first connecting portion and the second connecting portion which are arranged face to face interposing an adhesive so that the connecting portions are brought into contact with each other, and heats and compresses the first and second connecting portions,
wherein a recess portion is formed on a compressing face of the compressing tool which comes into contact with the soft substrate.
